(19) United States
(12) Patent Application Publication
(10) Pub. No.: US 2024/0336024 A1
(43) Pub. Date: Oct. 10, 2024

(54) METHOD FOR IN-SITU MANUFACTURING A PROTECTIVE LINER ON AN ELONGATED STRUCTURAL PART OF AN AIRCRAFT

(71) Applicant: Airbus Operations GmbH, HAMBURG (DE)

(72) Inventor: Jose MARTINS, HAMBURG (DE)

(21) Appl. No.: 18/626,507

(22) Filed: Apr. 4, 2024

(30) Foreign Application Priority Data
Apr. 6, 2023 (EP) 23167138.9

(51) Int. Cl. B29D 99/00; B64C 1/06

(52) U.S. Cl. CPC B29D 99/0014; B64C 1/066

(57) ABSTRACT

To allow the in-situ manufacture of a protective liner for an elongated finished structural part, it is proposed to mechanically attach a sealant mold portion to the elongated finished structural part, specifically the surface to be protected. The sealant mold portion in cooperation with the elongated finished structural part forms a mold cavity which gets injected with a wet sealant. The wet sealant cures into a cured sealant member which is bonded to the surface and acts as a protective liner.

### CROSS-REFERENCES TO RELATED APPLICATIONS

This application claims the benefit of the European patent application No. 23167138.9 filed on Apr. 6, 2023, the entire disclosures of which are incorporated herein by way of reference.

### FIELD OF THE INVENTION

The invention relates to a method for in-situ manufacturing a protective liner on an elongated structural part of an aircraft. The invention further relates to an in-situ mold arrangement used during the method.

### BACKGROUND OF THE INVENTION

EP 3 205 470 A1 discloses the manufacture of parts made of thermoplastic material, where injection means are used to inject the thermoplastic material, e.g., polyamide.

EP 1 860 250 A2 discloses a seal for a facade system.

EP 2 839 946 A2 discloses a transfer system and a method for applying a film material to an elongate member.

EP 2 176 123 A1 discloses a composite laminate structure having an edge and an impact indicator which is carried by the edge.

US 2017/0 152 949 A1 discloses a sealant containment assembly where at least a portion of a fastener pattern is bound between at least two components, such as components used to form a portion of an aircraft. The sealant containment assembly includes at least one sealant containment member that sealingly engages peripheral portions of the components. The sealant containment member forms a sealing chamber around at least a portion of the fastener pattern. Fluid sealant flows into the sealing chamber and cures to seal fasteners within the fastener pattern that connect the components together.

GB 2 588 967 A discloses an aircraft structure, e.g., a stringer, rib, spar or rib attachment, that has a composite laminate body. The body has an edge and an edge cap covering the edge, wherein cured resin forming part of the body bonds the edge cap on the edge. The aircraft structure is manufactured by providing a dry fiber preform of a structural component, covering an edge of the preform with an edge cap, feeding or injecting uncured resin between the edge cap device and the edge of the preform to infuse the dry fiber preform and curing the resin.

DE 10 2014 017 411 A1 discloses a method for manufacturing a fiber composite part. A thermoplastic or elastomeric edge protection is attached to an edge of the fiber composite before the matrix of the fiber composite component is cured. After attaching the edge protection, the matrix of the fiber composite component is cured.

EP 4 249 200 A1 discloses a method for manufacturing a protective lining for aircraft parts. As an example, a tank wall liner can be manufactured in-situ by casting the sealant into a prepared mold that is formed at least at the bottom side by the part to be protected by the tank wall liner. Specifically, for fuel tanks, the bottom portion forms the bottom side of the mold, whereas the ribs and stringers form a circumferential wall of the mold that prevents flowing of the potting sealant compound into neighboring molds.

### SUMMARY OF THE INVENTION

It is an object of the invention to improve the in-situ manufacture of protective liners.

The invention provides a method for in-situ manufacturing a protective liner on an elongated structural part of an aircraft, the method comprising:
a) attaching a sealant mold portion on an elongated finished structural part of an aircraft in a detachable and non-movable manner, the elongated finished structural part having a surface to be protected, wherein the sealant mold portion gets arranged such that the sealant mold portion and the surface to be protected form a sealant mold having a mold cavity;
b) filling the mold cavity with a wet sealant;
c) curing, or letting cure, the wet sealant into cured sealant that is bonded to the surface and forms a protective liner; and
d) removing the sealant mold portion from the elongated finished structural part.

With this approach an edge protection can be formed on a structural part that is already installed in an aircraft fuselage. This is particularly suitable for metal structural parts.

Preferably, in step c) the curing, or letting cure, is carried out in-situ with the sealant mold portion attached to the elongated finished structural part.

Preferably, step d) is performed after step c). Preferably step d) is performed immediately after step c).

Preferably, the sealant mold portion comprises an injection opening that fluidly connects to the mold cavity, and in step b) the wet sealant is filled into the mold cavity through the injection opening.

Preferably, the sealant mold portion comprises a discharge opening that fluidly connects to the mold cavity, and in step b) the wet sealant is filled, preferably injected through the injection opening, into the mold cavity until some of the wet sealant is discharged through the discharge opening.

Preferably, the elongated finished structural part comprises a top portion that, when the elongated finished structural part is installed on a skin of a fuselage, is spaced apart from the skin, and the surface to be protected is part of the top portion and faces away from the skin. Preferably, in step a) the sealant mold portion is arranged on the top portion of the elongated finished structural part such that the sealant mold portion and the top portion define the mold cavity.

Preferably, the elongated finished structural part comprises at least one lateral portion that, when the elongated finished structural part is installed on a skin of a fuselage, is spaced apart from the skin, and the surface to be protected is part of each lateral portion and faces parallel to the skin. Preferably, in step a) the sealant mold portion is arranged on each lateral portion of the elongated finished structural part such that the sealant mold and each lateral portion define the mold cavity.

Preferably, in step b) the wet sealant is injected with an injection pressure of 0.5 bar to 10 bar. Preferably, the method is performed at a temperature from 10° C. to 30° C.

Preferably, the wet sealant is a self-curing sealant. Preferably, the wet sealant is chosen from a group consisting of polysulfide based sealant, polythioether based sealant, epoxy based sealant, and polyurethane based sealant.

Preferably, the sealant mold portion comprises or is made of a non-stick material that is configured such that the wet sealant does not bond to the sealant mold. Preferably, the sealant mold portion is made of metal coated with the non-stick material. Preferably, the non-stick material is chosen from among a group consisting of a release agent, PTFE or a fluorosilicone.

The invention provides a sealant mold arrangement suitable for in-situ manufacturing a protective liner on an elongated structural part of an aircraft, the arrangement comprising an elongated finished structural part of an aircraft, the elongated finished structural part having a surface to be protected, wherein a sealant mold portion is attached to the elongated finished structural part in a detachable and non-movable manner such that the sealant mold portion and the surface to be protected form a sealant mold having a mold cavity.

Preferably, the sealant mold portion comprises an injection opening and a discharge opening each fluidly connecting to the mold cavity, wherein the injection opening and the discharge opening are arranged relative to each other such that, when wet sealant gets injected through the injection opening, the wet sealant has to pass through the entire mold cavity along at least one direction of the elongated structural part before reaching the discharge opening.

Preferably, the elongated finished structural part comprises a top portion that, when the elongated finished structural part is installed on a skin of a fuselage, is spaced apart from the skin, and the surface to be protected is part of the top portion and faces away from the skin. Preferably, the sealant mold portion is arranged on the top portion of the elongated finished structural part such that the sealant mold and the top portion define the mold cavity.

Preferably, the elongated finished structural part comprises at least one lateral portion that, when the elongated finished structural part is installed on a skin of a fuselage, is spaced apart from the skin, and the surface to be protected is part of each lateral portion and faces parallel to the skin. Preferably, the sealant mold portion is arranged on each lateral portion of the elongated finished structural part such that the sealant mold and each lateral portion define the mold cavity.

The ideas presented herein are generally useful for protecting structural parts against abrasion or mechanical wear. One idea is their application in rear center tanks of aircraft. The rear center tanks of aircraft are typically formed by elongated finished structural parts, such as frames and stringers. Typically, these parts exhibit some surfaces that would be exposed towards the tank cavity.

Here, these surfaces can be protected by application of a self-curing wet sealant using adapted mold portions and wet sealant injection. The whole process can be designated as wet sealant injection molding.

The wet sealant is injected into an in-situ formed mold, i.e., the mold is formed by an attached mold portion and the part to be protected. The wet sealant is cured in-situ with the mold attached such that the cured sealant can protect the structural part against abrasion/mechanical effects. Furthermore, protection against corrosion and leakage can be included.

Suitable self-curing wet sealants are generally known in the field. Examples include MC238 and MC780 available from Chemetall/BASF or PR1782 and PR2001 available from PPG Aerospace. The wet-liquid could be also epoxy, polyurethane, etc., that cures and can form a specific geometry.

In general, the geometry of the part to protect can form the base of the mold. Typical thickness of the sealant is between 0 mm and 200 mm, preferably from 1 mm to 15 mm, more preferably from 3 mm to 10 mm. The sealant material can be chosen from sealing materials including polysulfide or polythioether or, more generally, any kind of liquid that cures after a time and can form the required geometry.

With this solution additional curing, e.g., in a curing oven or autoclave can be avoided. In fact, it is advantageous to avoid pre-cured parts entirely to reduce manufacturing complexity caused by, among others, logistics.

This idea can avoid additional positioning by manual labor which uses positioning devices. In contrast to other solutions, it is easier to manufacture the protected parts in the same factory.

Typical surfaces to protect are on structural parts, such as stringers, frames and couplings. These parts can be protected against abrasion of the liner (rubber) that is installed on top of the structure to protect against an impact.

In general, the following steps are performed. Applying a mold portion (e.g., made from PTFE) around the part (e.g., stringer, frame, etc.) and mechanically fixing the mold in a detachable manner. Injecting the wet sealant into the mold until the squeeze out of sealant indicates that the wet sealant has fully covered the area. This can be done using injection and discharge openings. The injection and discharge openings can be made separately or be formed on the end portions of the mold portion. After injection, the whole area is typically filled with wet sealant and then there is a wait for the sealant to cure. The final step is removing the mold after the sealant is cured. In this manner, the shape of the cured sealant will confirm to the specific molds.

### BRIEF DESCRIPTION OF THE DRAWINGS

Embodiments of the invention are described in more detail with reference to the accompanying schematic drawings that are listed below

FIGS. 1A to 1C depict a first embodiment of a method for in-situ manufacturing of a protective liner for an elongated finished structural part viewed along the structural part;

FIGS. 2A-2C depict a second embodiment of the method; and

FIGS. 3A-3C depict a third embodiment of the method.

### DETAILED DESCRIPTION OF THE PREFERRED EMBODIMENTS

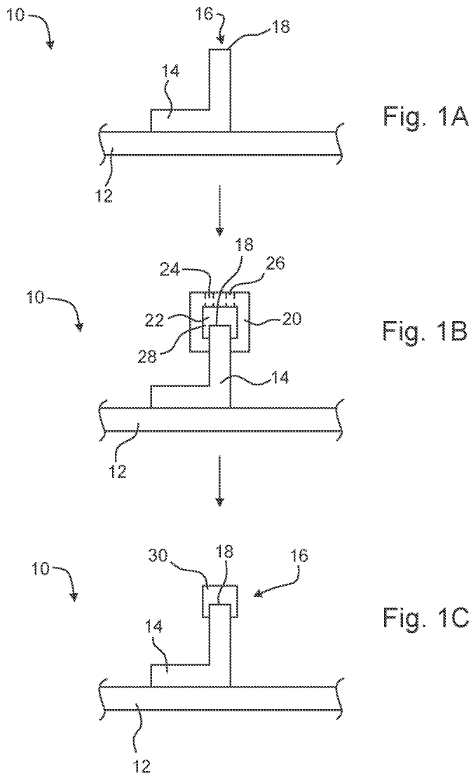

Referring to FIGS. 1A-1C, a first embodiment for in-situ manufacturing of a protective liner for an elongated finished structural part is described in more detail.

Initially, a fuselage 10 is provided. The fuselage 10 comprises a skin 12 and an elongated finished structural part 14 as shown schematically in an end view in FIG. 1A. The elongated finished structural part 14 extends along a longitudinal direction (in and out of the drawing) and is preferably a profile part. The elongated finished structural part 14 is preferably formed via a constant cross-section extrusion process. Examples for the elongated structural part 14 are structural reinforcement parts, such as a rib, frame or stringer. The elongated finished structural part 14 comprises a top portion 16 that is spaced apart from the skin 12. The top portion 16 is configured as an edge portion and comprises a surface 18 that is to be protected from mechanical wear. The top portion 16, especially the surface 18, extend along the longitudinal direction of the elongated finished structural part 14.

A wet sealant mold portion 20 is arranged so as to cover the surface 18 as shown schematically in a cross-sectional view in FIG. 1B. The wet sealant mold portion 20 and the elongated finished structural part 14, specifically the top portion 16, cooperatively define a mold cavity 22. A preferred size of the mold cavity 22 (thickness distance from interior surfaces of the wet sealant mold portion 20 to opposing outer surfaces of the elongated finished structural part 14) is about 3 mm to 10 mm. However, the mold cavity 22 may reach up to 200 mm in thickness. The wet sealant mold portion 20 may include an injection opening 24 that is in fluid communication with the mold cavity 22. The injection opening 24 may be formed within a top surface of the wet sealant mold portion 20, as depicted in FIG. 1B, or can be formed in a lateral surface (not shown).

The wet sealant mold portion 20 may further include a discharge opening 26. The discharge opening 26 is in fluid communication with the mold cavity 22. The discharge opening 26 may be formed in a top surface of the wet sealant mold portion 20, as depicted in FIG. 1B, or can be formed in a lateral surface (not shown).

The injection opening 24 and the discharge opening 26 are arranged relative to each other such that a fluid injected through the injection opening 24 has to pass through an entire length of the mold cavity 22 in order to reach the discharge opening 26, where the fluid can be discharged. In other words, the injection opening 24 and the discharge opening 26 can be arranged relative to each other such that a fluid, e.g., uncured wet sealant, flows on the surface 18 along the longitudinal direction of the elongated finished structural part 14, preferably starting from the injection opening 24 and towards and/or out the discharge opening 26. In a variant, the injection opening 24 and/or the discharge opening 26 are formed on the proximal and distal end portions of the wet sealant mold portion 20, when viewed along the longitudinal direction of the elongated finished structural part 14.

As indicated in FIG. 1B, the injection opening 24 and the discharge opening 26 can, in addition, be spaced apart along a lateral direction of the wet sealant mold portion 20. Consequently, fluid can pass along the entire length of the wet sealant mold portion 20 before being discharged through the discharge opening 26.

In a next step, still referring to FIG. 1B, an uncured wet sealant 28 is injected into the mold cavity 22. Preferably, the injection opening 24 through the injection opening 24 into the mold cavity 22 until some of the uncured wet sealant 28 is discharged from the discharge opening 26.

The wet sealant mold portion 20 is kept fixed to the elongated finished structural part 14 until the uncured wet sealant 28 has cured into a cured sealant member 30. The cured sealant member 30 preferably has simultaneously bonded to the elongated finished structural part 14, specifically to the surface 18. The wet sealant mold portion 20 is then removed and the cured sealant member 30 now forms a protective liner that protects the surface 18 from mechanical wear, for example, from abrasion, as shown in FIG. 1C.

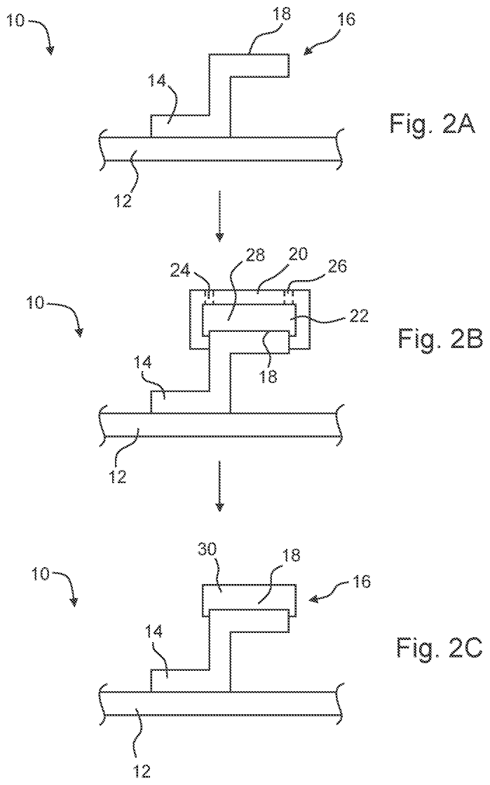

Referring to FIGS. 2A-2C, a second embodiment of the method is described insofar as it differs from the first embodiment. In this variant, the top portion 16 extends in parallel to the skin 12 as shown in FIG. 2A. The surface 18 extends along the top portion 16 and for the thickness of the top portion 16. Otherwise, the steps of the method are substantially the same as in the first embodiment.

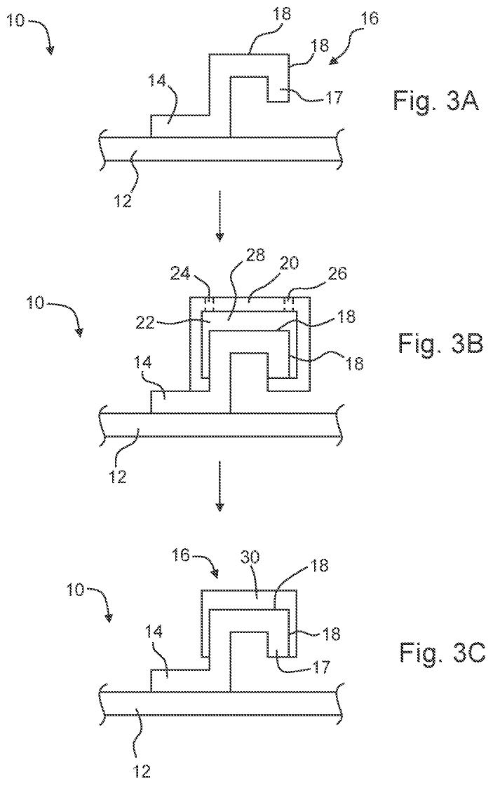

Referring to FIGS. 3A-3C, a third embodiment of the method is only described insofar as it differs from the first embodiment. In contrast to the first embodiment, the elongated finished structural part 14, preferably the top portion 16, further includes a lateral portion 17 as shown in FIG. 3A. The lateral portion 17 protrudes towards the skin 12. In this embodiment, the surface 18 is arranged on the lateral portion 17. Otherwise, the steps of the method are substantially the same.

In order to allow the in-situ manufacture of a protective liner for an elongated finished structural part 14, it is proposed to mechanically attach a sealant mold portion 20 to the elongated finished structural part 14, specifically the surface 18 to be protected. The sealant mold portion 20 in cooperation with the elongated finished structural part 14 forms a mold cavity 22 which gets injected with a wet sealant 28. The wet sealant 28 cures into a cured sealant member 30 which is bonded to the surface 18 and acts as a protective liner.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

10 fuselage
12 skin
14 elongated finished structural part
16 top portion
17 lateral portion
18 surface
20 wet sealant mold portion
22 mold cavity
24 injection opening
26 discharge opening
28 uncured wet sealant
30 cured sealant member

1. A method for in-situ manufacturing a protective liner on an elongated structural part of an aircraft, the method comprising:
a) attaching a sealant mold portion on the elongated finished structural part of the aircraft in a detachable and non-movable manner, the elongated finished structural part having a surface to be protected, wherein the sealant mold portion is arranged relative to the elongated finished structural part such that the sealant mold portion and the surface to be protected form a sealant mold having a mold cavity;
b) filling the mold cavity with a wet sealant;
c) curing, or letting cure, the wet sealant into cured sealant that is bonded to the surface and forms the protective liner; and
d) removing the sealant mold portion from the elongated finished structural part.

2. The method according to claim 1, wherein in step c) the curing, or letting cure, is carried out in-situ with the sealant mold portion attached to the elongated finished structural part.

3. The method according to claim 1, wherein step d) is performed after step c).

4. The method according to claim 1, wherein the sealant mold portion comprises an injection opening that fluidly connects to the mold cavity, and in step b) the wet sealant is filled into the mold cavity through the injection opening.

5. The method according to claim 4, wherein the sealant mold portion comprises a discharge opening that fluidly connects to the mold cavity, and in step b) the wet sealant is filled, by being injected through the injection opening, into the mold cavity until the wet sealant is discharged through the discharge opening.

6. The method according to claim 1, wherein the elongated finished structural part comprises a top portion that, when the elongated finished structural part is installed on a skin of a fuselage of the aircraft, is spaced apart from the skin, and the surface to be protected is part of the top portion and faces away from the skin, wherein in step a) the sealant mold portion is arranged on the top portion of the elongated finished structural part such that the sealant mold portion and the top portion define the mold cavity.

7. The method according to claim 1, wherein the elongated finished structural part comprises at least one lateral portion that, when the elongated finished structural part is installed on a skin of a fuselage, is spaced apart from the skin, and the surface to be protected is part of each lateral portion and faces parallel to the skin, wherein in step a) the sealant mold portion is arranged on each lateral portion of the elongated finished structural part such that the sealant mold and each lateral portion define the mold cavity.

8. The method according to claim 1, wherein in step b) the wet sealant is injected with an injection pressure of 0.5 bar to 10 bar.

9. The method according to claim 1, wherein the method is performed at a temperature from 10° C. to 30° C.

10. The method according to claim 1, wherein the wet sealant is a self-curing sealant.

11. The method according to claim 10, wherein the wet sealant is chosen from a group consisting of polysulfide based sealant, polythioether based sealant, epoxy based sealant, and polyurethane based sealant.

12. The method according to claim 1, wherein the sealant mold comprises or is made of a non-stick material that is configured such that the wet sealant does not bond to the sealant mold.

13. The method according to claim 12, wherein the non-stick material is PTFE or a fluorosilicone.

14. An in-situ sealant mold arrangement suitable for in-situ manufacturing a protective liner on an elongated finished structural part of an aircraft, the arrangement comprising:
the elongated finished structural part of an aircraft having a surface to be protected,
wherein a sealant mold portion is attached to the elongated finished structural part in a detachable and non-movable manner such that the sealant mold portion and the surface to be protected form a sealant mold having a mold cavity.

15. The arrangement according to claim 14,
wherein the sealant mold portion comprises an injection opening and a discharge opening each fluidly connecting to the mold cavity, and
wherein the injection opening and the discharge opening are arranged relative to each other such that, when wet sealant gets injected through the injection opening, the wet sealant has to pass through the entire mold cavity along at least one direction of the elongated structural part before reaching the discharge opening.

16. The arrangement according to claim 14, wherein the elongated finished structural part comprises a top portion that, when the elongated finished structural part is installed on a skin of a fuselage, is spaced apart from the skin, and the surface to be protected is part of the top portion and faces away from the skin, wherein the sealant mold portion is arranged on the top portion of the elongated finished structural part such that the sealant mold and the top portion define the mold cavity.

17. The arrangement according to claim 14, wherein the elongated finished structural part comprises at least one lateral portion that, when the elongated finished structural part is installed on a skin of a fuselage, is spaced apart from the skin, and the surface to be protected is part of each lateral portion and faces parallel to the skin, wherein the sealant mold portion is arranged on each lateral portion of the elongated finished structural part such that the sealant mold and each lateral portion define the mold cavity.
